(19) United States
(12) Patent Application Publication
(10) Pub. No.: US 2002/0161595 A1
(43) Pub. Date: Oct. 31, 2002

(54) Business knowledge plug & play system or KOWAK

(76) Inventor: Carlos Victor Cepeda, Vitacura (CL)

Correspondence Address: CARLOS CEPEDA, AV. KENNEDY 5454 OF. 1602, VITACURA, SANTIAGO, 6680217, CL

(21) Appl. No.: 09/844,510

(22) Filed: Apr. 30, 2001

(51) Int. Cl. G06F 17/60

(52) U.S. Cl. 705/1

(57) ABSTRACT

A set of business processes to produce immediately Ready to Use (Plug & Play) Reports and Datamarts reflecting the Best Industry Practices that extracting data from ERP or similar packages databases at a fraction of today's cost (around 5%). The set of business processes includes an Architecture to identify what is to be made, the fabrication, selling, delivering, maintenance, user community and a feedback mechanism

### CROSS REFERENCE TO RELATED APPLICATIONS

Not Applicable.

### STATEMENT REGARDING FEDERALLY SPONSORED RESEARCH OR DEVELOPMENT

Not Applicable

### REFERENCE TO A MICROFICCHE APPENDIX

Not Applicable

### BACKGROUND OF THE INVENTION

The invention pertains to business information obtained from business software packages databases, like ERPs or CRMs, presented to users as applied knowledge in the forms of reports and datamarts at 5% of today market cost.

ERP, Data Warehouse, BI.

Over the past few years, many companies have been replacing their in-house software application developments with general purpose applications created by global software companies, most notably Germany's SAP, the Dutch company Baan, the American PeopleSoft and between ten and twenty other vendors.

ERP (Enterprise Resource Planning) applications are sometimes referred to as World Class Software, and may be adapted to different types of companies all over the world. The process of adaptation, involving external consulting, can take from six months to several years. The out-of-pocket expenses can fluctuate between one and three dollars per dollar spent on software licenses.

The implementation costs of an ERP application range from an out-of-pocket minimum of US$100,000 to tens of millions of US dollars. The end result is an excellent operational system that gathers and stores enterprise data. Normally, the process of retrieving this data in the form of reports is not explicitly included in the project's costs. This item is left for a later stage in the process. Normally users are unhappy as they get the job of inputting the operational data but lack reports to benefit from the information that they loaded into the systems.

Therefore, we are now in a situation where, independently of their size, companies have improved their business processes, generating vast amounts of data but failing to take advantage of it. There is a big market opportunity open for the exploitation of this data. Numerous tools and technological solutions are being developed to exploit the data that is available. Notable among these are Data Warehouse Technologies and Business Intelligence (BI) tools.

Data Warehouses are data repositories designed to expedite the analyses fed from the operating systems where data is organized to accelerate transaction-processing times. Normally a project for a Data Warehouse can take several years and cost millions of dollars to implement. In practice, many companies have bought software tools to implement them but have failed to deliver.

Business Intelligence tools supplied by several vendors provide self-service to end users to access operational data bases and Data Warehouses. These tools are easy to sell based on ease of use but in practice users stop using them as they lose proficiency for lack of use, and continue to recourse to external or internal resources to develop ad hoc programs.

In sum, companies are spending time and money but are not obtaining the results they expected or might expect from the use of the ERP application. KP&P estimates they should spend an unbudgeted 20 to 30% of the original ERP implementation budget in order to achieve appropriate results. That is, expenditures in the order of several tens of thousand to over a million dollars are required.

There is an additional opportunity brought by the ERPs. Companies all over the world are buying the same or similar standard software, allowing for the sharing of experiences by not competitive markets. A local Food and Beverage Company in a country might be willing to share experience with companies in other countries, but might not be willing to do it with a local one. If a product can be offered repeatedly to those companies through a Web site it will become a natural vehicle of communications to reach peer companies.

Market Trends

There are several trends in the global economy that affects the industrial market and which are very positive for a system like KOWAK.

ERP Popularization

This is the most important trend. Good quality integrated data, standard within each ERP, is now ready to use. This allows for compatibility in the reports and data marts among different companies. The ERP explosion has created a lack of qualified people. Even now, users are unsatisfied with expensive applications that usually underestimate or do not consider reporting and data mart costs.

Globalization

Global companies are growing by acquiring Local companies with different or no ERP at all, forcing them to adopt one or to otherwise adapt to the global standard. Therefore there will be more ERP implementations and a more room for cross-ERP products.

Vendorization

Companies are outsourcing entire functions and fast becoming Virtual Companies operating with Vendors and Customers that have different ERPs. Those companies that have no ERP as yet are being forced to adopt one in order to improve their business processes and become active contestants. Consequently, there will be more ERP implementations and more cross-ERP products.

BI Popularization

Efficient tools for data retrieval and analysis are becoming increasingly popular. Client Service and Web tools are converging, which means that efforts made with one tool, such as report writing are easily transferred to the Web. BI tools are easy to sell. Users get excited during the selling process but stop using them shortly after that (Exercise Bike Syndrome).

E-Business.

Companies are emigrating to the Web, which renders obsolete their Reporting Systems. Reports written with BI tools are not affected.

Data Warehousing.

ERPs are providing vast amounts of data that can be organized in the form of Data Warehouses for analysis purposes. However, this process is expensive and takes a long time to implement.

Information Overflow/Paradigm Shift.

Information is elsewhere and difficult to find, the framework of information that all professionals have is a fast moving target. Almost all companies need help in understanding the technologies that are currently available. Many have purchased Data Warehouse and BI technologies without fully understanding their implications, relying on the understanding that comes from using them. This is an expensive exercise if the wrong technology is chosen.

Isolation

Business pressures do not allow IT and Users—especially in smaller companies—to share their experience with their peers. The most interesting peer might be anywhere in the world.

Market Background

According to IDC, the ERP market has been growing at an annual rate of 40% during the past few years, and is expected to continue growing 30% a year. The ERP market represented US$16 B in 1998 and business forecasts indicate that it should reach US$64 B by 2003. In terms of revenues, the largest providers are SAP with US$ 5 billion, Oracle ERP with $2.4 B, PeopleSoft ($1.3B), JDEdwards ($979 million) and Baan ($743million). Source: Fortune Dec. 6, 1999. These companies sell mainly to companies with over US$50 million in Revenue.

Market trends indicate that ERP and BI acceptance will accelerate regardless of any specific system implementation horror stories. With a few exceptions, the market in general agrees that benefits exceed costs. E-business acceptance will also make the incorporation of new implementations more difficult, forcing current ERP customers to continue moving, making it difficult for IT to go back and complete the promised reports and data marts.

Major ERP providers are now focusing on smaller companies and therefore, the growth rate in terms of the number of systems installed is expected to increase. The smaller the company, the more willing to accept standardized solutions it will be, as the processes of such companies are more standard, and the they will look to reduce cost of implementation.

### BRIEF SUMMARY OF THE INVENTION

KOWAK is a Business Information System that extracting data from the companies' ERPs or similar software packages, honoring their security protocols, provides its users with knowledge reflecting the best industry practices, ready to use (Plug & Play) at a fraction of today's cost (around 5%) thanks to its scope of reaching all ERPs, BIs and similar packages and its architecture, production, commercial, distribution and operational systems, that allows to define, to build, to license, to distribute, to advise on use, to feedback, to correct, to expand the number of products of packaged knowledge allowing client companies to make available to their users tools and ready to use reports accessing their operational data, in their premises, and helping them to manage in a way that reflects the Best Practices of doing Business.

How Does KOWAK Affects the Described Trends:

ERP Popularization

Good quality integrated data, standard within each ERP, is now ready to use, allowing for compatibility in the reports and data marts among different companies. KOWAK provides these Reports and Data Marts at a fraction of the cost (around 5%) without requiring qualified people. Also, by leveraging its implementation methodology, it reduces implementation time and costs. New companies using KOWAK Needles & Noodles Architecture will be able to establish the reports and datamarts they expect to get with the ERP implementation, improving communication with the vendors, reducing false expectations and setting up their respective businesses with the best practices embedded in the products.

ERP vendors should look to KOWAK, as a tool that will increase the sale of licenses to more customers, increasing their satisfaction and reducing the skill required for the implementation.

Globalization

Global companies are growing by acquiring Local companies with different or no ERP at all; Companies will be able to implement different ERPs with the same KOWAK Reports and datamarts user Interface

Vendorization

Companies are outsourcing entire functions and fast becoming Virtual Companies operating with Vendors and Customers that have different ERPs. With KOWAK they will still have the same reports and datamarts, only difference being the ERP source data will be different.

BI Popularization

BI tools are easy to sell. Users get excited during the selling process but stop using them shortly after that (Exercise Bike Syndrome). KOWAK takes advantage of these products, which have already been sold. With its instant data marts, users can immediately reap the benefits of the technology, saving them the embarrassment of not using what they bought. The same applies to these tools' marketing channels.

E-Business

Companies are migrating to the Web, which renders obsolete their Reporting Systems. Reports written with BI tools are not affected. KOWAK should ease the migration process.

Data Warehousing

Data Warehouse are expensive and takes a long time to implement. New techniques now make it possible to implement Departmental subsets known as Data Marts, which if further implemented as Dimension Conformed Data Marts, as KOWAK, and obtaining their data from ERPs, can operate as Virtual Data Warehouses, reducing the time to benefit for the most lucrative data marts.

Information Overflow/Paradigm Shift

Many companies have purchased Data Warehouse and BI technologies without fully understanding their implications, relying on the understanding that comes from using them. This is an expensive exercise if the wrong technology is chosen. Low cost technologies such as KOWAK have a potential as an educational, real-life, low cost exercise.

Isolation

Business pressures do not allow IT and Users—especially in smaller companies—to share their experience with their peers. The most interesting peer might be anywhere in the world. KOWAK Plaza lets them access all KOWAK customers.

### BRIEF DESCRIPTION OF THE SEVERAL VIEWS OF THE DRAWING

FIG. 1. KOWAK in the evolution scale

FIG. 2. KOWAK Inventory Management Example

FIG. 3. KOWAK Selling and Distribution, user perspective

FIG. 4. KOWAK Type of Users

FIG. 5. KOWAK Making All Combinations

FIG. 6. KOWAK Technology at the Factory

FIG. 7. KOWAK Process at the Factory

FIG. 8. KOWAK Datamart Product

FIG. 9. KOWAK Needles & Noodles Architecture

FIG. 10. KOWAK Report usage

FIG. 11. KOWAK Datamart Usage

FIG. 12. KOWAK Plaza

FIG. 13. ERP/BI Normal Implementation

FIG. 14. ERP/BI Implementation with KOWAK

### DETAILED DESCRIPTION OF THE INVENTION

KOWAK is Business Information Systems that provides knowledge and knowledge retrieval products in the form of ready-to-use (Plug & Play) reports and virtual data warehouses (at a fraction of today's costs), reflecting the best business practices currently in use, helping companies to improve management and growth through an immediate and inexpensive use of their own data.

KOWAK takes advantage of the standardization brought by ERPs, the facilities provided by BI tools and the communication, sales and distribution capabilities available with Internet to provide at a never seen cost reports and datamarts ready to use at the clients premises.

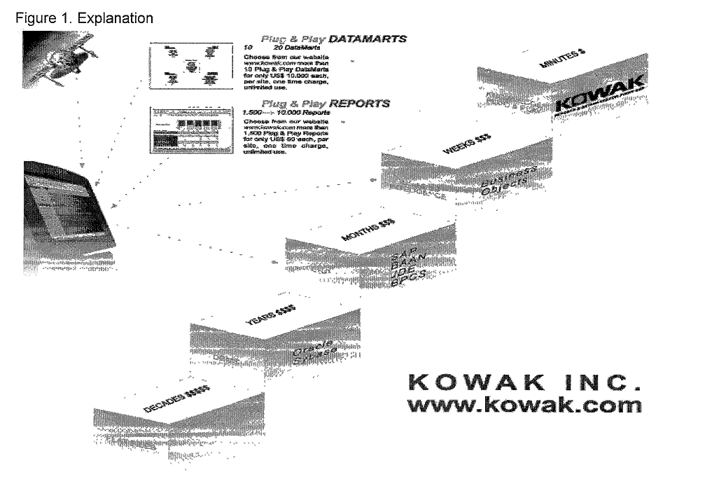

KOWAK represent an evolution following the developing of ERPs and BI as shown in FIG. 1.

KOWAK Business Information Systems is composed of:

Products: reports and datamarts reflecting mostly the best practices in the industry that obtains data from any ERP.

Web Site: Commercial and Distribution arm. KOWAK is sold and maintained using the Web though is also possible to market it thorough different channels. The products are sold by unit (around US$50 a Report) plus a 15% maintenance annual fee or by subscription, where the user pays and initial fee, around US$5.000 and then a $1.000 annual fee, per site or division or country. For the 15% fee the client gets all new versions of the reports or datamarts and receives all fixes and can submit modifications, suggestions or problems. For the subscription the user gets all available or future reports and datamarts without additional cost. The products are delivered and maintained via Web. User can ask new reports or modification of existing one.

Factory: Reports and datamarts production systems that prepare reports and datamarts extraction, and transformation programs that work with any ERP and BI.

The reports are produced in any language and are set so the user can use his own dictionary to adapt the reports automatically to the words used in his installation Plaza: A place of encounter for users of KOWAK. Clients can share or demand information from KOWAK or from other users.

Business Architecture called Needles & Noodles reflecting the relationship of every process in a company and the reports and datamarts that helps supporting them

ERP Implementation Methodology that working in conjunction with others incorporates the KOWAK System to save significant amounts of time and money in the implementation of any ERP.

KOWAK Products

KOWAK Reports

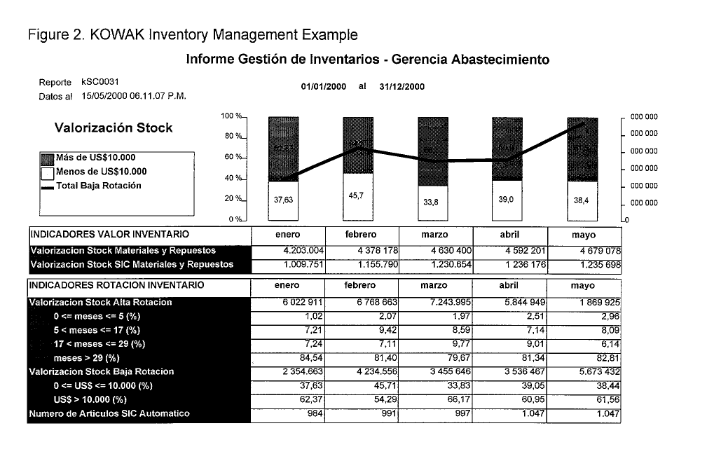

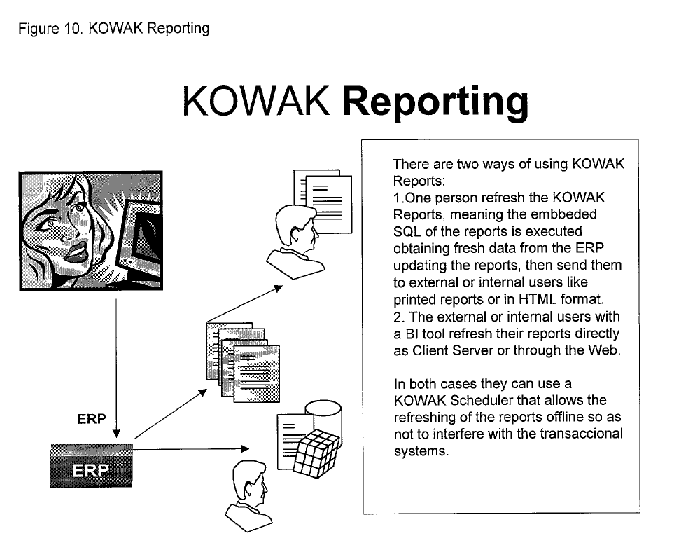

Addresses the Trends listed previously: Globalization, Vendorization, e-business, ERP User insatisfaction, ERP Implementation Costs, ERP Post-implementation Costs and BI popularization difficulties with a number of Reports that take advantage of the ERP Data Storage standardization and BI tools that give access to ERP Data. The reports reflect the best business practices and are provided at a fraction of the cost (5%) of alternative methods. See FIG. 2 as an example how KOWAK obtains the Best Practices in Industry. FIG. 10 KOWAK Report Usage, shows how users use the Reports. Client can add their own logo the reports. Can search for a word or synonym, functional organization or process. If a client switches ERP he can for a 50% fee the reports and datamarts for the new ERP, keeping the same user Interface.

KOWAK DataMarts

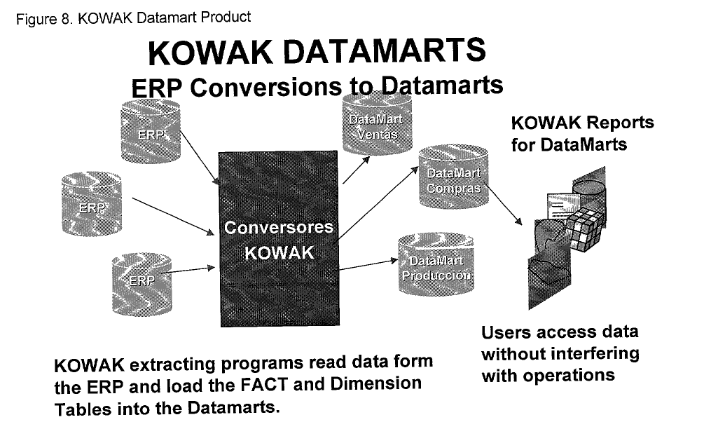

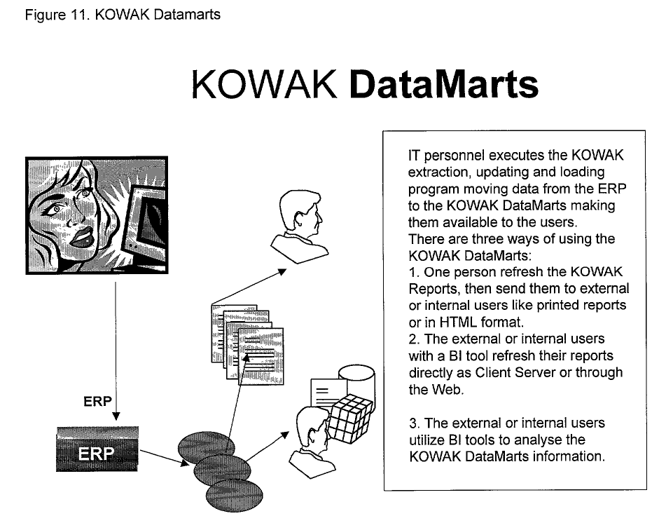

Using data marts' common dimensional architecture, KOWAK's implementation methodology delivers DataMarts designed to be common to all ERPs, providing a ready to use Virtual Data Warehouse with the data retrieval program from the ERP and the load and update program built into the DataMarts. BI Tools are then used to analyze the DataMarts, a set of Reports are also provided. FIG. 8 KOWAK Datamart Product and FIG. 11 KOWAK Datamart Usage, shows how the datamarts are used. Datamarts are expected to be sold around US$3,000.

KOWAK Website

KOWAK Products are ready to use. The vehicle for delivery and sales is the KOWAK Website. The proof of concept is also available at the Website. The potential customer can download demo reports that come with a script telling the customer's IT personnel what tables and fields of the ERP they should authorize the user to access in order to execute the report. The script is set up honoring the security procedures of the installations. Only specific system installation parameters should be given, such as user name or database name. With the script execution the customer tests the Reports, in his installation with his own data.

The customer buys and downloads products from the Website and can start using them immediately after IT executes the script provided, which authorizes him to access the data to be read by the reports. After this, he can modify the names of the fields of the reports to reflect those used in their companies, can ask for customized reports and can communicate with KOWAK personnel and other customers.

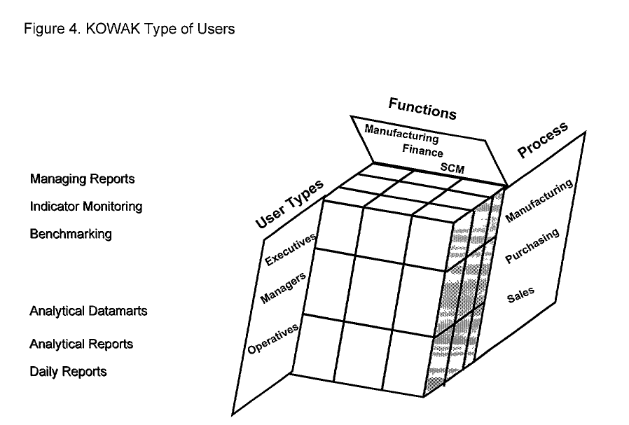

A search tool is provided to help the customer select those reports that interest him: He can ask for all reports applicable to a given process, such as Sales, or else to a department, such as Accounting. Also, he may ask for reports including specific fields, such as Customer Name and Purchased Amount. FIG. 4 Type of Users, shows how the search tool can locate the applicable reports for a function, a process or a type of user.

A customizing tool allows the customer to select the fields of the Fact table conformed dimension and granularity and then prepares the unload file containing the retrieval, loading and updating programs and the Oracle or SQL Server Data Definition together with a script file containing the proper authorization instructions which, after being executed, allow the customer to begin using his data mart in its installed system.

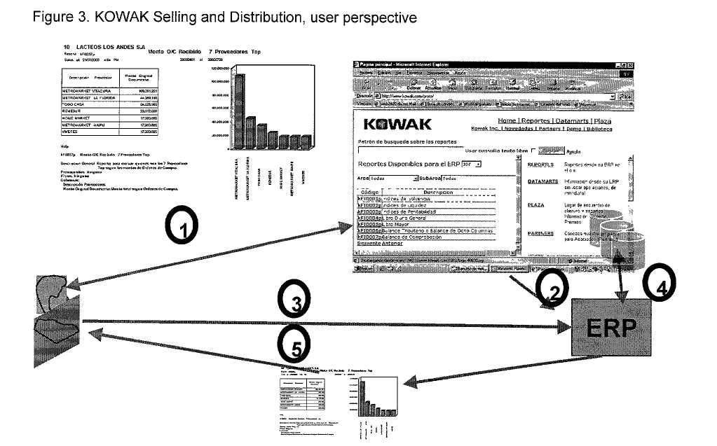

The KOWAK site is a place where users will find what they have been expecting from their ERPs. They can find the reports they need using a computerized report generator, including ones they never thought about, including the best practices in industry, or even ask for a specific one. FIG. 3 KOWAK Selling and Distribution User perspective, shows how a user will interact with the KOWAK site and how will use its products.

Clients can share using the KOWAK systems performance indicators obtained with the reports, that are then put in a confidential aggregate or summarized form so users can benchmark there indicators with other in industry obtained with the same tools, comparing effectively apples with apples.

The client can access a Report or datamarts in the Web see what modification he wants and use the same vehicle or Fax to return to KOWAK as a suggestion of new or a modification of the reports. This is the essence of the feedback the KOWAK System uses to keep ahead of the Best Business Practices.

The Web site has a tool so the user can estimate his actual cost of preparing a Report making explicit all people and activities involved. There is a default of around US$1000 per Report but the user can modify the parameters and calculate the cost using his own parameters. The user can position in any field of the report as shown in the web and see the meaning of the fields.

The user can download a report try it for a week and then decides if he purchase it. The reports have a demo Password allowing its free use for a week.

Factory.

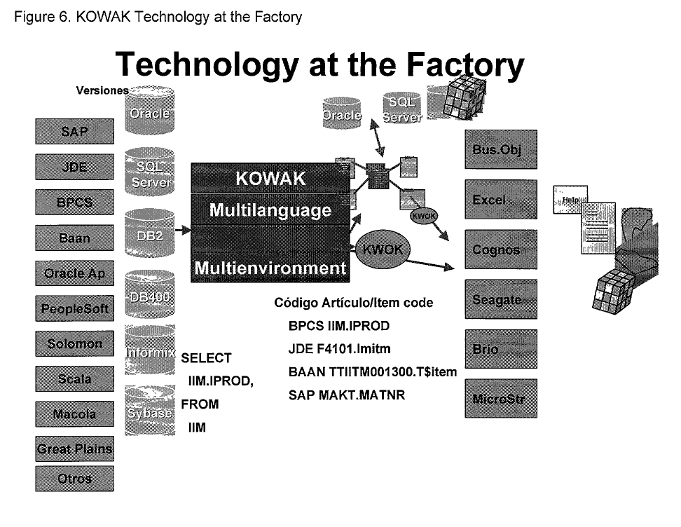

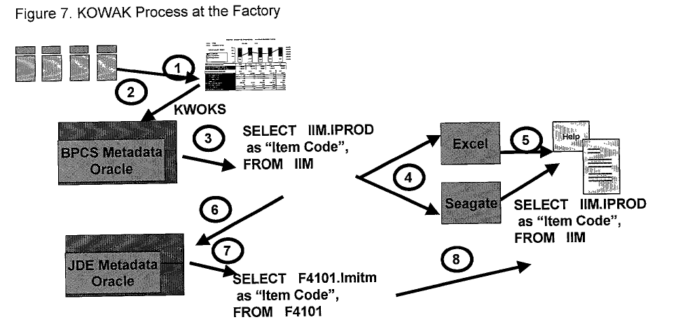

KOWAK Reports and Datamarts are prepared for every combination through an orderly process as depicted in FIG. 6, Technology at the Factory, at a fraction of the total cost that would involved to developed every pair without having a scope of doing it all like shown in FIG. Making all Combinations. The actual process of fabrication is shown in FIG. 7. Process at the Factory

KOWAK Plaza

KOWAK Plaza offers general interest information to customers, the ability to communicate with their peers from all over the world and links to other related portals. It is expected that in the future KOWAK Plaza will become one of the primary portals for industrial customers, becoming a meeting place where customers may share and seek knowledge. This is the way KOWAK addresses the Trend Information Overflow and Isolation.

KOWAK Plaza will be a knowledge-sharing site where users may find answers to their ERP and/or BI questions. The site will allow them to post questions and start discussion groups on specific subjects they are interested. KOWAK design and product quality is critical to the positioning as a dot company.

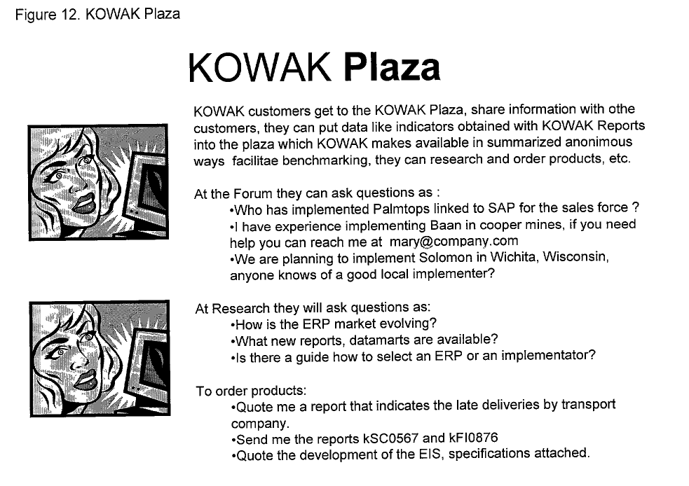

KOWAK Plaza will promote customer fidelity. Dedicated personnel will generate events to increase Plaza traffic. They will also be responsible for improving and increasing Web Content and to propose new features to expedite sales and customer support. FIG. 12 KOWAK Plaza, shows examples of the intention of the Plaza. Business.

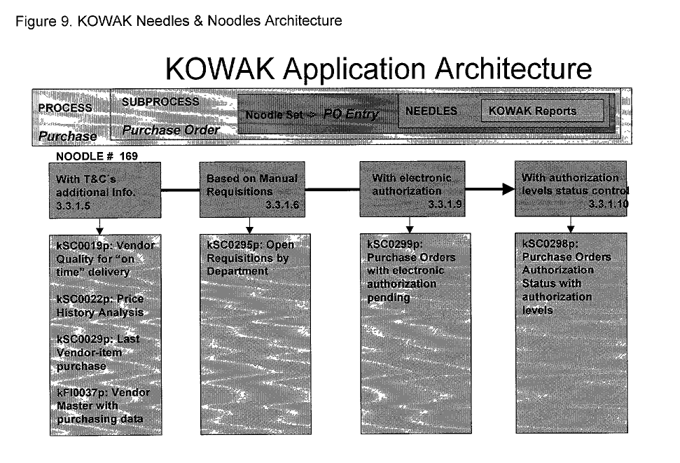

Needles & Noodles Architecture. See FIG. 9 Needles & Noodles Architecture.

ERP Implementation Methodology.

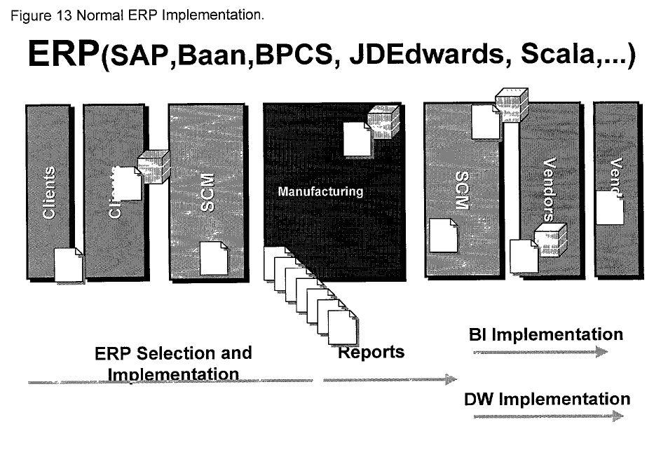

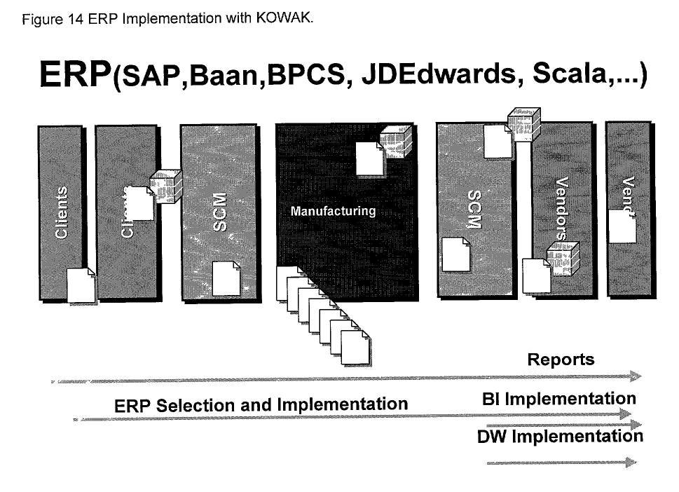

Composed of guidelines that working in conjunction with others ERP Implementation Methodologies incorporates the KOWAK System to save significant amounts of time and money in the implementation of any ERP as shown in FIGS. 13 ERP/BI Normal Implementation Methodology and FIG. 14 ERP/BI Implementation Methodology with KOWAK.

With KOWAK using the Needles & Noodles Architecture, all needs are identified ahead of time and included in the ERP implementation, normally at a lower cost. When the ERP implementation is finished the users get all they were expecting at the same time. KOWAK provides an ERP Implementation.

For those customers in the process of selecting an ERP, KOWAK will provide a clear picture of the reports and data marts they should include in their RFP (Request for Proposals), forcing the various vendors to specifically include the cost of KOWAK or a similar, more expensive solution. KOWAK Plaza will also include an ERP selection guide. There is a different behavior, depending on the company's size. Larger companies need indexes and data marts that allow them to understand their business. Smaller companies need more operational reports and less analytical reporting. KOWAK provides both.

State of the Art Today.

Although there are many ERP vendors and a fair amount of BI vendors and consulting firms, neither of them addresses the information needs that are satisfied by KOWAK Reporting, DataMarts and Plaza in an integrated, ready-to-use system.

Most reports and datamarts come today from in-house development or small consultancy and programming firms addressing local needs.

Reporting has always been considered a non-challenging occupation by IT professionals that would rather do more interesting developments, therefore it is likely that they will welcome KOWAK and help promote it with their users.

Data marts are considered IN today. Most IT people would like to be involved but it's difficult and expensive to cope with, and many times this matter is left in the hands a selected pilot group. With the proper tools and methodologies provided by KOWAK, anyone can participate in speeding up the technology adoption. After they get the operating experience they can add to the Data Mart their unique data, which is sourced from non-ERP systems. IT people should also support KOWAK for Data Marts.

ERP vendors are concentrating their efforts on providing increased functionality, like moving into CRM or e-business where they can leverage their size and unique knowledge. It is unlikely they will deliver a solution like KOWAK, as they would be limited to their own base. If they moved into other ERPs, they would face the opposition of the other ERPs providers. Also the broadness of KOWAK offer, being cross ERP and cross BI allows it to reach a broader base and is a major element of attraction for multinational with different ERPs and/or BIs.

ERPs do not provide the wide coverage that KOWAK will. Some companies are beginning to offer DataMarts and Warehouses but at a much higher cost and implementation time.

FIG. 1 represents the evolution of Information Technology since the 60s. In the 60 and 70s each company developed its own applications and had there own filing systems. Each application satisfied the local needs disregarding the global information required by the company. Incompatible, duplicate application dependant data were often the case.

In the 70s data base technology permitted the sharing of data among different applications, accelerating the application development processes as they were developed taking advantage of existing databases. There were not as many success stories as expected as the applications were developed without the data model fully complete. The time to conceptualize the data model proved longer than expected and applications started their development without waiting for the data model, producing some incompatibilities.

In the 80s and 90s the ERPs were popularized. They were world class software that did essentially the same that in house developed applications were supposed to do, but integrating all data and functions. As these ERPs were designed to work with many type of companies they required to be adapted and specialized consultants were brought in for the implementations. The cost of writing a report once the ERP is installed takes weeks and cost over one thousand dollars.

The ERPs produced a great quantity of good reliable, quality data. Companies can then think on new applications to capitalize on that data like CRM (Customer Relationship Management) or BI (Business Intelligence) to analyze the data: New data organizations were popularized like data warehouses or datamarts.

The ERPs, CRMs and BI are developed with a global market perspective and bring standardization to the way companies do business everywhere. Companies use the same tool and the same know how, nevertheless user expectation grow faster that the solutions are delivered; everywhere there is a lack of skilled personnel. BI tools though easy to use, if not used frequently, users loose the skills.

The scenario for a new stage is set:

Thousand of companies have the same data base organization (from the ERP) and naming conventions within the ERP

Companies are used to standard business processes

Companies are hard pressed for results

Companies are looking forward to implement the Best Practices in Industry

The new scenario is Knowledge Plug & Play, knowledge in the form of finished reports and datamarts reflecting the Best Practices and readily available through the Web, so the users can download them and begin to use in their installation at a fraction of the normal cost.

FIG. 2 shows an example of an Inventory Management Reports, that reflects the Best Practices in Industry and is a very good example how KOWAK Business model acquires and includes the Best Practices. The reports, along 28 others, were designed by Booz Allen for a Chilean Mining Company, user of the ERP Baan. KOWAK developed the reports to extract the data form the ERP Baan, at a very low price but in exchange was authorized to use the format of the reports for other companies. The same procedure will be used with other company as they ask for reports not yet available in KOWAK.

FIG. 3 represents the user perspective of the KOWAK System.

1. The client access the KOWAK Web site, he is looking for ideas how to better understand his vendors. Using the searchers available in KOWAK he finds a reports he judges adequate, for instance a simple Vendor Ranking, he displayed the report, he look at the helps that explains each field. The report in the figure is the actual report he might have seen.

2. The client decides to buy the report, he indicates to KOWAK the ERP he uses, for instance JDEdwards, the BI version he wants, for instance Excel, and also that instead of Vendor he prefers the world Supplier. The user goes through the purchasing procedures then download the report. He could have optionally downloaded a demo version. If he wants he disconnect from the Web.

3. Some time later the user ask the IT department to authorize his access to the tables and field used by the report. The report has previously indicated those to him showing a sample of what the IT people would have to do. The client loads the report in his PC and press the “Refresh Button”

4. The system receives the instruction of going to the ERP database to get the proper information. As it has been previously authorized, it does.

5. The system sends the data to the report that present them to the user.

The report is now a company report, the user can use it in any PC in his company, and it cost him US$50 and only minutes to get it running. No programming was involved.

FIG. 4 represents the different type of users. The cube of the figure shows how different function needs like in finance, purchasing or manufacturing are addressed with reports and datamarts; similarly different type of employee, like executives or operatives or different process needs, like purchasing or selling are addressed. This integrated vision of the information needs allow KOWAK to reduce the total number of reports and datamarts needed to satisfy a company, further reducing the total cost of reporting. This who-needs-which-reports is not limited to three dimensions, it will be expanded to ERP specifics, complexity level, Company size, Industry, etc.

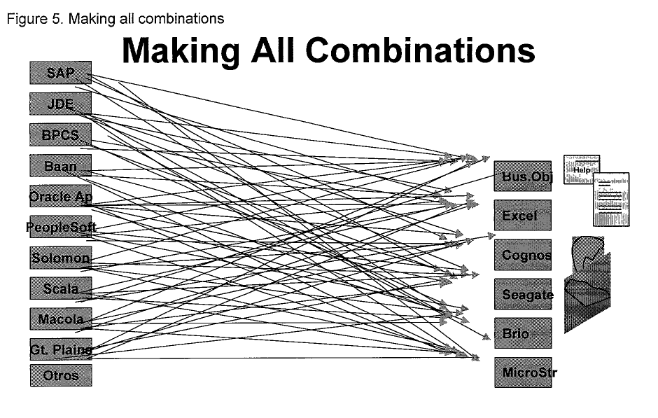

FIG. 5 shows the necessary work if a one to one approach were used

FIG. 6 represents the technology used in the KOWAK factory. It is based on the standardization of tables and field names brought by the ERPs.

Every component has a name that identifies it and that is the same within the particular ERPs. There are same exceptions with user fields that are handled separated. The ERP vendors keep the names very stable as to avoid changes in their programs.

In the example of the figure the Item number:

In BPCS is in the table IIM field PROD

In Baan is in the table TTITM001300 field T$item

In SAP is in the table MAKT field MATNR

KOWAK (The invention) has Metadatas defined for every supported ERP and its versions, when a report is needed the Pre-Report builder thanks to the defined metadatas generates the required SQL for the data needed by the report (the SELECT and FROM statement in the example), then produce and element called KWOK that is ERP independent that has the name to be used as default in the report, for instance “Item Code” in English or “Código Artículo” in Spanish.

The KWOK is fed into the reports regardless of the Business Intelligence tool to be used for presentation or into the ETL (Extraction Transformation and Loading) program that will be used to load or update a datamart.

FIG. 7 represents the fabrication process;

1. A report is selected from the Needles & Noodles Architecture

2. The Reports specification are inputted to the Pre Report Builder indicating BPCS as the target ERP, Oracle as the database.

3. The SQL for every field or aggregation of fields is prepared to access BPCS Oracle Databases

4. The SQL is attached to the Report to be written in EXCEL or Seagate for instance by a programmer

5. The reports are produced with the same formats, with the tools, with its Help. WE have the Reports written once for Excel and once for Seagate. Only one help, one format were prepared, also one SQL was automatically prepared

6. The Reports specification are inputted to the Pre Report Builder indicating JDE as the target ERP, Oracle as the database.

7. The SQL for every field or aggregation of fields is prepared to access JDEdwards Oracle Databases.

8. The SQL prepared for JDE replaces in a copy the BPCS' SQL in the EXCEL and Seagate version of the report. No need to rewrite the Excel or Seagate report, no programming is involved

To prepare the same report for other ERP, the Pre Report Builder translate the SQL using the metadatas of the other ERP and replaces the attached SQL for the report version of the new ERP. The pre report builder takes into consideration special conditions of the ERPs and hardware environment, like converting the DECODE SQL instruction for Oracle to the CASE WHEN for DB/400.

With this scope of preparing the reports for all ERPs and BIs there is a significant saving:

Each user interface report need to be written once for every Business Intelligence tool

The metadatas are written for every ERP, then the SQL are produced automatically

In the case of datamarts the extraction, transformation and load program includes the SQL to the target data to be extracted from the ERP and the SQL to load the data into the predefined relational or multidimensional database previously where users will be able to access and analyze the data using a BI. The most common reports used with these data are provided

FIG. 8 shows the way the Datamarts are provided, KOWAK provides visual basic programs with the embedded SQL to extract the fields that will populate the target datamarts, today, as relational database. The data is aggregated if necessary and all defined fact and dimension tables are loaded.

FIG. 9 shows the partially the Needles and Noodles Architecture developed to identify all activities and the necessary information needed to support them. A needle is the minimum activity in a company. A noodle is the process that put together the needles.

In the figure examples of needles are:

Purchase Order Entry with T&Cs

Purchase Order Entry based on manual requisition

Purchase Order Entry with electronic authorization

Purchase Order Entry with authorization levels

Example of Noodle would be the one that links the Purchase Order Entry with T&C with other needles or activities. For every needle the supporting reports were defined like in the figure. There is a family of base reports, about one to two thousand, and related similar reports, over ten thousand so the user can choose the one that fits most which his requirements.

The Needles & Noodles Architecture is used to decides what reports and datamarts to build and also to help the user to find the required reports to support a particular activity.

FIG. 10. The figure shows how the user after purchasing the report, load it its system, and use it. It is not necessary to be connected to the Web; this is merely a delivery vehicle. The report is self-sufficient in the client premises.

FIG. 11. The figure shows how the user after purchasing the datamart, load it its system, and use it. It is not necessary to be connected to the Web; this is merely a delivery vehicle. The datamart is self-sufficient in the client premises.

FIG. 12 represents the KOWAK Plaza, one of the vehicles for the users to share information and ask for improvements. One of the principal source of feedback to keep ahead on the incorporation of Best Practices into KOWAK.

FIG. 13 shows how normally in the middle of an implementation the client discover that will get the system in operation but the users will not get what they are expecting as reports are not available, and not budget was assigned for this purpose. Separate projects are set up to develop the reports, normally after the system is up and running, the users have to put up with what they get until the reports, if there is budget available are developed. The even after that user find out that they will also need a Business Intelligent Tool to access a Datawarehouse or datamarts. At the end the user has to wait for up to three projects to satisfy his expectation.

FIG. 14 shows an ERP Implementation with KOWAK, where all reports, datamarts and Business Intelligence Tools can be delivered simultaneously.

1. What I claim as my invention is the Business Information System that extracting data from the companies' ERPs or similar software packages, honoring their security protocols, provides its users with knowledge reflecting the best industry practices, ready to use (Plug & Play) at a fraction of today's cost (around 5%) thanks to its scope of reaching multiples ERPs, BIs and similar packages and its architecture, production, commercial, distribution and operational systems, that allows to define, to build, to license, to distribute, to advise on use, to feedback, to correct, to expand the number of products of packaged knowledge allowing client companies to make available to their users tools and ready to use reports accessing their operational data, in their premises, and helping them to manage in a way that reflects the Best Practices of doing Business.
The originality of the claim is the broad scope that provides a single source for software, information and best practices at a fraction of the cost as a result of all the processes described working together.
